(19) United States
(12) Patent Application Publication
(10) Pub. No.: US 2017/0226764 A1
(43) Pub. Date: Aug. 10, 2017

(54) AUTOMATED PARKING SYSTEM FOR VEHICLES

(71) Applicant: Nussbaum Technologies GmbH, Kehl-Sundheim (DE)

(72) Inventor: Hans Nussbaum, Kehl-Bodersweier (DE)

(73) Assignee: Nussbaum Technologies GmbH, Kehl-Sundheim (DE)

(21) Appl. No.: 15/502,598

(22) PCT Filed: Jun. 9, 2015
(86) PCT No.: PCT/EP2015/062844

§ 371 Date: Feb. 8, 2017

(30) Foreign Application Priority Data
Aug. 27, 2014 (DE) 10 2014 112 269.0

(51) Int. Cl. E04H 6/18; E04H 6/36; E04H 6/34; E04H 6/24; E04H 6/22

(52) U.S. Cl. CPC E04H 6/18; E04H 6/24; E04H 6/22; E04H 6/34; E04H 6/36; B62B 2202/90

(57) ABSTRACT

In order to provide an automated parking system for vehicles in which a vehicle which is to be parked is parked on a pallet at a transfer station and the pallet is then transferred by a mechanical device and moved to a storage location, and which, on the one hand, is technically simple, and therefore has little susceptibility to faults, and is cost-effective, and on the other hand can make it possible to use existing storage areas as parking space with minor structural modifications and installations, according to the invention multiple pallets are provided which can be stored at storage locations of the parking system at a raised level with respect to the floor of the building in such a way that a low-floor maneuvering vehicle can drive under them. Furthermore, at least one robotically controlled, low-floor maneuvering vehicle is provided for transporting the pallets, the maneuvering vehicle having an omni-directional drive and being equipped with a preferably hydraulic lifting device in order to lift a pallet which has been driven under.

### BACKGROUND

The invention relates to an automated parking system for vehicles, particularly motor vehicles, in which a vehicle to be parked is placed at a transfer station onto a pallet and the pallet is then transferred by a mechanical device and moved to a parking space. Additionally, the invention relates to a respective mechanical device for an automated parking system as well as a method for storing vehicles in an automated parking system.

Parking space for vehicles is frequently sparse and expensive in congested areas and primarily in city centers. The building of above-ground and underground parking garages requires expensive investments so that there is a desire to use the parking spaces created as efficiently as possible. This leads to the fact that in many parking garages parking spaces are marked, which are too narrow, particularly for larger vehicles, and the respective vehicle can be moved into them with difficulty only. If such parking situation develops in parking garages, here the risk increases that during the entering and leaving process but also when opening the vehicle doors the parking or neighboring vehicle is damaged. Frequently the efficiency of utilization, particularly in narrow parking garages, also suffers in that parking gaps remain which are too narrow for any vehicle to be parked therein.

For this reason, automated parking garages were suggested in which a vehicle to be parked is placed by the user onto a transfer station, is accepted by a mechanical device, and moved in the parking garage to a certain parking space. Upon request by the operator the vehicle is retrieved from the parking space and provided for use by the operator at the transfer station or another delivery station.

Among other things, parking systems are known in which the vehicles are placed onto pallets, which are transferred by horizontally moving load carriers, and moved to a lifting platform. The lifting platform then drives to the desired parking space, with the load carrier perhaps also being pivoted so that the horizontally extending load carrier reaches the correct parking space. After lowering the motor vehicle including its pallet the load carrier returns and the lifting platform is ready for another process.

Such space-saving parking systems are subject to extraordinarily costly investments for the transportation system, namely essentially due to the expensive technical conveyance system and its control.

Furthermore, low-floor maneuvering vehicles have been suggested, by which vehicles to be parked are preferably engaged at their wheels and lifted in order to move the vehicles then in a space-saving fashion to respective parking spaces. Such maneuvering devices are known for example from the publications U.S. Pat. No. 5,268,156; U.S. Pat. No. 5,037,263; and U.S. Pat. No. 8,016,303. However, here it has shown to be problematic that vehicles to be parked exhibit completely different geometries, such as clearance, wheel base, tire size, etc., which render any automated lifting and lowering of the vehicles by the maneuvering vehicle to be expensive and susceptible to errors. Additionally, the sensitive drive systems of modern vehicles can be compromised by an inappropriate lifting process due to respective impact of strong forces. It is therefore understandable that the willingness of operators is low to trust their vehicles to such an automated parking technology.

A multi-level parking system with an elevator is known from the publication US 2007/0098528 in which every vehicle is placed onto a separate parking platform and in which all parking platforms are autonomous in their movability and maneuverability. By a respective control the parking platforms can be arbitrarily maneuvered within a parking level like a puzzle piece so that only very little maneuvering space is required to allow moving any arbitrary platform to the elevator. Due to the fact that for every vehicle to be parked a separate, autonomously driven and controlled parking platform is required, the above-described parking system is technically expensive and thus costly. Additionally, when one parking platform malfunctions due to a technical defect, here an entire parking level including the vehicles parked therein may be blocked so that the risk for the parking system to fail is accordingly high.

### SUMMARY

Thus, the objective of the present invention is to provide a parking system as well as a corresponding mechanical transportation device and a method for an automatic parking of vehicles, which on the one hand is technically simple and thus has low susceptibility to malfunction and is cost-effective, on the other hand can utilize existing storage space as parking space with minor structural changes and installations.

With regards to the automated parking system, the mechanical transportation device, and the method, the objection is attached using one or more features of the invention. Advantageous embodiments are discernible from the description and claims.

In the automated parking system of the type mentioned at the outset according to the invention a plurality of pallets are provided, which can be stored on parking spaces of the parking system at an elevated position in reference to the floor such that they can be driven under completely by a low-floor maneuvering vehicle. Furthermore, at least one robot-controlled, low-floor maneuvering vehicle is provided for transporting pallets, which shows an omnidirectional drive and is equipped with a preferably hydraulic lifting device in order to lift the pallet driven under.

The parking system according to the invention comprises, except for the maneuvering vehicle and a potentially given elevator system, no mobile and/or moved parts and thus it can be designed in an appropriately simple fashion and is robust against malfunctions. In the event of a defect the maneuvering vehicle can easily be exchanged and/or an appropriate redundancy can be achieved by providing two or more maneuvering vehicles for the operation. The omnidirectional drive of the maneuvering vehicle allows a space-saving maneuvering on the smallest space such that the parking space available can be utilized in the best possible fashion. The pallets themselves may be designed in light-weight construction and thus accordingly cost-effective. Due to the fact that no structural changes, no installations or attachments, such as rails, guides, chain pulls, or the like are required, existing storage space can be converted quickly and perhaps even only temporarily into parking space.

The maneuvering vehicle is robot-controlled, thus like a driverless transportation vehicle with a master control for an automatic control of the maneuvering vehicle. Additionally, it has a separate drive as well as devices for determining its location and detecting the situation such that it can move autonomously within the parking system. Devices for data transmission serve to obtain commands from a central control of the parking system and to transfer confirmation, error, and/or alarm messages to the central control.

Preferably individually addressed wheel drives with omnidirectional wheels may be used as the drive for the maneuvering vehicle. In particular, the drives may be formed by so-called Mecanum-wheels. This way it is possible to create a maneuvering vehicle in a simple fashion, which can drive with utmost precision within a parking level in any arbitrary direction and can perform rotations and/or reversions on the spot as well as rectangular changes of direction. The parking system therefore requires only minimal moving space. Alternatively, so-called drive-spin modules may be used, which utilize a classical drive wheel which additionally is actively spun about its vertical axis and can be aligned.

The parking system according to the invention can particularly utilize a multi-level storage building for storing the pallets with parked vehicles, with the individual parking levels being connected via a preferably hydraulic elevator system, having a lifting platform or elevator cabin which can be accessed by the maneuvering vehicle. It is therefore possible to bring a delivered vehicle, parked on a pallet at the transition station, by the maneuvering vehicle via the elevator system to any arbitrary parking level and to store it there. Preferably, an elevator shaft with an appropriately positioned lifting platform and/or elevator cabin of the elevator system can serve as the transfer station for dropping off and picking up the parked vehicle. Thus the dropping off and return of a vehicle occurs in a separate, closed transfer room such that the operator him/herself is not granted any access to the parking levels. Within the scope of the present invention it is however also possible to provide a transfer room, independent from the elevator system, which is closed and/or can be closed by suitable gates, allowing the maneuvering vehicle to drive thereon.

Due to the fact that the pallets are elevated in reference to the floor of the parking level in order to allow being driven under by the maneuvering vehicle, here the vehicle to be parked drives upon the pallet at the transfer station, preferably via a ramp. If the drop-off and/or return of a vehicle occurs in an elevator shaft of an elevator system the lifting platform and/or elevator cabin of the elevator system with the empty pallet located therein can also be lowered in reference to the external road level such that the top of the pallet is at the same level as the external road level such that a vehicle can comfortably drive onto the pallet and off the pallet.

The energy supply of the maneuvering vehicle occurs preferably via rechargeable batteries and/or accumulators. Here a charging process is provided, by which the maneuvering vehicle can be coupled to a stand-by station. When the maneuvering vehicle is temporarily not required because no vehicles shall be stored or returned, or when the batteries of the maneuvering vehicle are dead, the vehicle moves to the stand-by station in order to charge its batteries.

The use of strong capacitors as an energy source is particularly preferred. Such strong capacitors, which can be recharged particularly quickly and tolerate a very high number of recharging cycles, are used for example in trams for energy recovery during the braking process. Due to the fact that such strong capacitors can be recharged very quickly, here a charging unit must be provided that uses inductive or tactile methods, by which the strong capacitor can be recharged when the maneuvering vehicle drives over or passes it.

The maneuvering vehicle can preferably be equipped with distance sensors, such as laser or radar sensors, by which it can determine at all times its precise position within a parking level. In addition, it is also possible to install a radio system for determining a position in interior spaces, which allow determining a position via triangulation based on radio signals or the like received, similar to known GPS-systems.

The particular advantage of the parking system according to the invention is its high flexibility and modular design. This way the parking system can be operated at all times with two or more maneuvering vehicles in order to increase the storage and/or return capacity. While for example a first maneuvering vehicle is occupied with the transportation of a motor vehicle to be parked from the transfer station to an allocated parking space, here a second transportation vehicle can already deliver a new storage pallet to the transfer station so that the parking system is immediately ready for accepting another motor vehicle. The operation of the parking system can initially be started with only one maneuvering vehicle and the operator can later procure additional maneuvering vehicles and add them to the parking system in order to shorten the waiting times and/or increase the storage and return capacities.

The operation of the parking system is preferably controlled by a central control, which communicates with the maneuvering vehicle or vehicles through a wireless interface, and orders them to move to a certain parking space in order to fetch a pallet therefrom or to deposit it there. Such a control is programmed to allocate parking spaces to motor vehicles to be parked and, in order to return a vehicle, to determine the respective parking space on which the pallet with said vehicle is stored, and to forward this position of the parking space to the maneuvering vehicle, which then approaches this parking space and fetches the respective pallet.

It is particularly advantageous if the pallets are stored in alleys behind and/or next to each other and the central control is embodied such that the pallets can be moved to grant access to pallets located further back in an alley. This way the parking space available can be used in a particularly effective fashion because not every pallet needs to be accessible at all times, but access can be granted if necessary by relocation. Here, too, the simultaneous operation of several maneuvering vehicles proves advantageous to improve access times. As another great advantage of the embodiment of the maneuvering vehicles and the elevated storage of the pallets it is possible here that a maneuvering vehicle can drive under the stored pallet, namely both in the lateral as well as the longitudinal direction.

If the return of a parked vehicle to the operator occurs at the same location as the drop-off, it is particularly comfortable for the operator when the maneuvering vehicle places the pallet with the vehicle to be returned here in a driving direction rotated by 180° in reference to the entering direction. This way, an operator can drive not only his/her vehicle forward onto the pallet, but can also drive off the pallet in the forward direction. By the use of the omnidirectionally driven maneuvering vehicles according to the invention this comfort function can be realized without problems and without any additional technical expense or turning space.

As an alternative to an omnidirectional drive the maneuvering vehicle can also be equipped with a differential drive. It has two driven wheels arranged along a lateral axis, which are driven separately via corresponding drives and independent from each other. For the purpose of stabilization the maneuvering vehicle comprises additionally at least one, preferably two support wheels which are freely mobile about their vertical axis. The differential drive allows spinning the maneuvering vehicle on the spot. For a lateral dislocating of a pallet picked-up in the longitudinal direction, here the pallet is first set down, the maneuvering vehicle under the pallet spins on site by 90°, and the pallet is then picked-up again with the new orientation.

### BRIEF DESCRIPTION OF THE DRAWINGS

In the following, additional features, advantages, and characteristics of the present invention are explained based on the figures and exemplary embodiments. Sown here are:

FIG. 1 a side view of a pallet, stored elevated in reference to the floor level, with a vehicle parked thereon,

FIG. 2 a top view of the pallet of FIG. 1,

FIG. 3 a pallet with a vehicle parked thereon, driven under by a maneuvering vehicle and lifted,

FIG. 4A a side view of the maneuvering vehicle of FIG. 3,

FIG. 4B a front view of the maneuvering vehicle of FIG. 3,

FIG. 4C a top view of the maneuvering vehicle of FIG. 3,

FIG. 5 a first exemplary embodiment of a parking level with vehicles parked on pallets,

FIG. 6 a second exemplary embodiment of a parking level with vehicles parked on pallets,

FIG. 7 an illustration of the principle of a Mecanum-wheel in a top view, to the tread of the wheel,

FIG. 7A an isometric illustration of a cylindrical roll, a plurality of which being arranged along the tread of the Mecanum-wheel,

FIG. 8 a longitudinal cross-section through the Mecanum-wheel of FIG. 7,

FIG. 9 a cross-section through the Mecanum-wheel of FIG. 7, and

FIG. 10 another exemplary embodiment of a maneuvering vehicle with a differential drive.

### DETAILED DESCRIPTION OF THE PREFERRED EMBODIMENTS

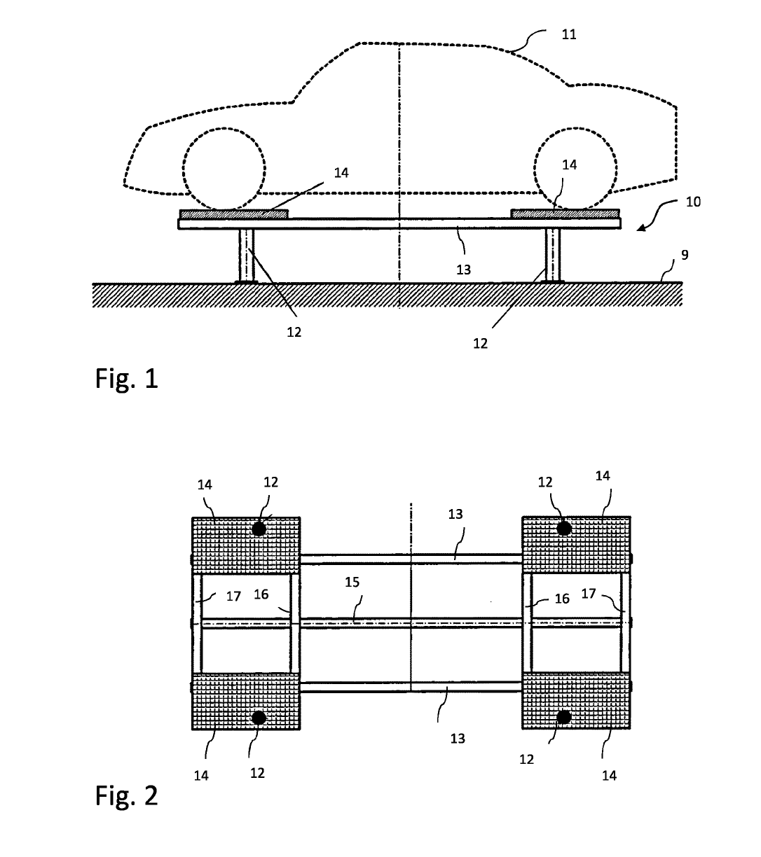

FIG. 1 shows a pallet 10 with a vehicle 11 parked thereon. The pallet 10 comprises lateral supports 12, by which it and the vehicle 11 placed thereon is positioned elevated in reference to the floor level 9 of a parking level. Longitudinal braces 13 at the side, together with lateral braces not shown in FIG. 1, form a supporting frame structure, which at the front and rear end respectively comprises four carrier areas 14, on which the wheels of the vehicle 11 to be parked come to rest.

The support area 14 are embodied and sized such that vehicles with all common wheel bases can be placed thereon. Within the scope of the present invention it is also possible to provide different pallets for various vehicle types and if necessary to render the appropriate pallet available based on a given axle situation determined or stated by the operator.

FIG. 2 also shows a top view on the pallet 10 of FIG. 1. The two longitudinal braces 13 at the sides connect at the two ends respectively internal and external lateral supports 16, 17, onto which the support area 14 is welded. For further stiffening the pallet 10 comprises an additional central longitudinal support 15. In the exemplary embodiment the supports 12 are provided underneath the support area 14, onto which the pallet 10 is placed.

As illustrated, the pallet 10 comprises a skeletal design such that it can be produced in light-weight construction from steel tubing and/or steel profiles or also from aluminum profiles.

Unlike the form shown in the figures, the longitudinal braces 13 may also have a form slightly arched upwards, allowing improvement of the static properties of the pallet. Instead of the separately fastened supports 12, the ends of the longitudinal braces 13 may also be angled downwards and this way serve as supports. Within the scope of the present invention it is also possible to completely omit the supports 12 of the pallets and instead thereof store the pallets on stationary support stands, connected fixed to the floor 9 of the level.

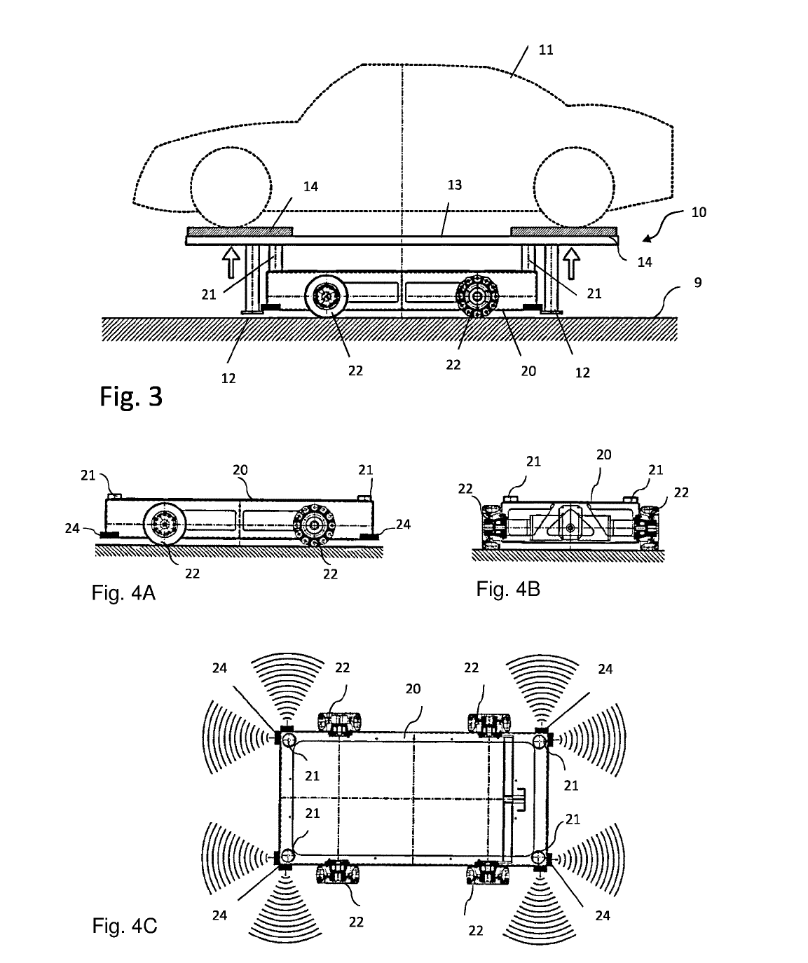

In the context with the present invention it is only important that the pallets 10 are supported elevated in reference to the floor of the level so that a low-floor maneuvering vehicle can drive completely under them and raise them. This situation is shown in FIG. 3. A maneuvering vehicle 20 is driven under the pallet 10 with the vehicle 11 resting thereon and has raised it via four hydraulic lifting plungers 21 such that the supports 12 do not contact the floor 9 of the level any longer. The maneuvering vehicle 20 can now drive with the pallet 10 and the vehicle 11 resting thereon to a parking space or to a transfer station and there lower the pallet 10 again. The maneuvering vehicle 20 obtains its high degree of maneuverability from an omnidirectional drive, which is formed by four so-called Mecanum-wheels in the exemplary embodiment. Instead of hydraulic lifting plungers, here other types of lifting devices can be used as well, such as scissor-type supports, lifting screws, or the like.

The maneuvering vehicle 20 is shown in various views in FIGS. 4A to 4C. The four Mecanum-wheels 22 are located laterally at the maneuvering vehicle 20 and they are each individually driven by a corresponding electric motor. The four lifting plungers 21 are located at the corners of the maneuvering vehicle 20, by which a pallet driven under can be lifted. Additionally, at the corners of the maneuvering vehicle 20 two distance sensors 24 are provided at each longitudinal and lateral side by which the maneuvering vehicle 20 can determine its position by measuring its distance from exterior walls of the parking garage, however, it can also detect potential obstacles and can avoid them or stop in due time. When using laser sensors it can additionally be helpful to provide reflectors at the walls of the parking garage in order to increase the range of the sensor-supported distance measurement.

Inside the maneuvering vehicle, in addition to the propulsion technology, an electrical supply unit is provided, for example in the form of rechargeable lithium-ion batteries or high-capacity capacitors, as well as an appropriate control for the drives and for navigating the maneuvering vehicle. Additionally, the maneuvering vehicle comprises a wireless interface, not shown in the figures, by which it can receive control commands from a central control of the parking system and transmit confirmation reports as well as potential alarm and error messages to the central control system.

The central control unit is preferably implemented via a respectively programmed data processing unit in a manner known per se. In addition to allocating parking spaces the control unit issues instructions for parking and/or returning vehicles as well as perhaps commands for relocating parked vehicles. Additionally the control unit can be used to approach access doors or gates of the parking garage and to open and close them for entering or retrieving vehicles.

The maneuvering vehicle 20 is embodied and sized such that it can drive under a pallet 10 between its supports 12. The omnidirectional drive allows a positioning of the maneuvering vehicle 20 with millimeter precision even under load, as well as a motion of the maneuvering vehicle 20 in any arbitrary direction in a level of a parking floor, particularly in the x-y direction of a virtual coordinate system and/or along transportation alleys and in storage alleys arranged perpendicularly in reference thereto.

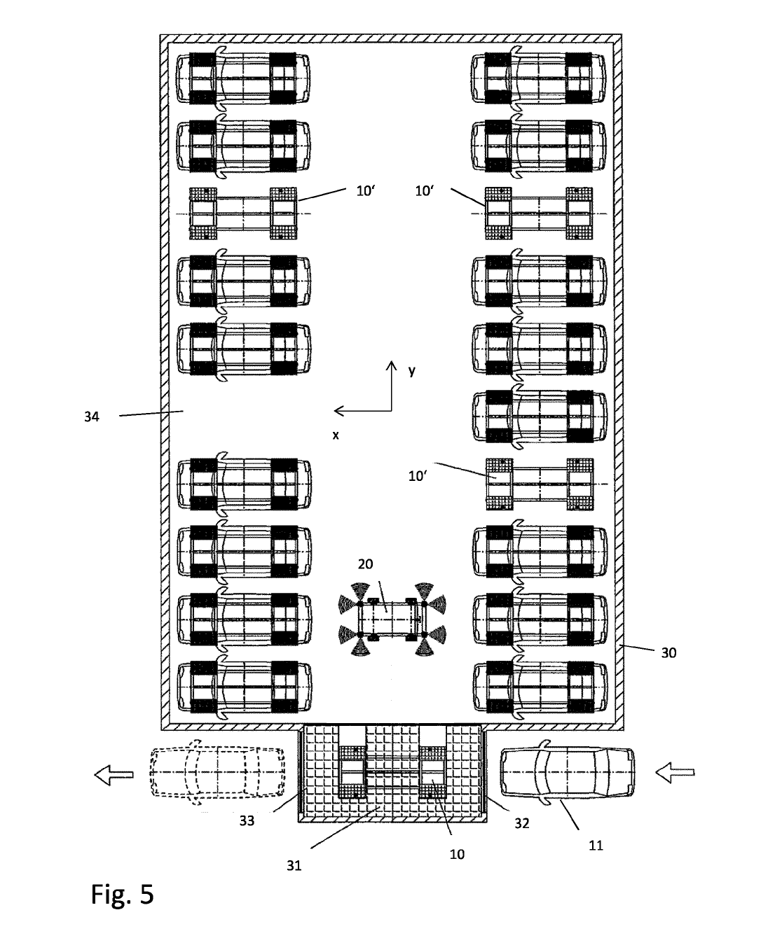

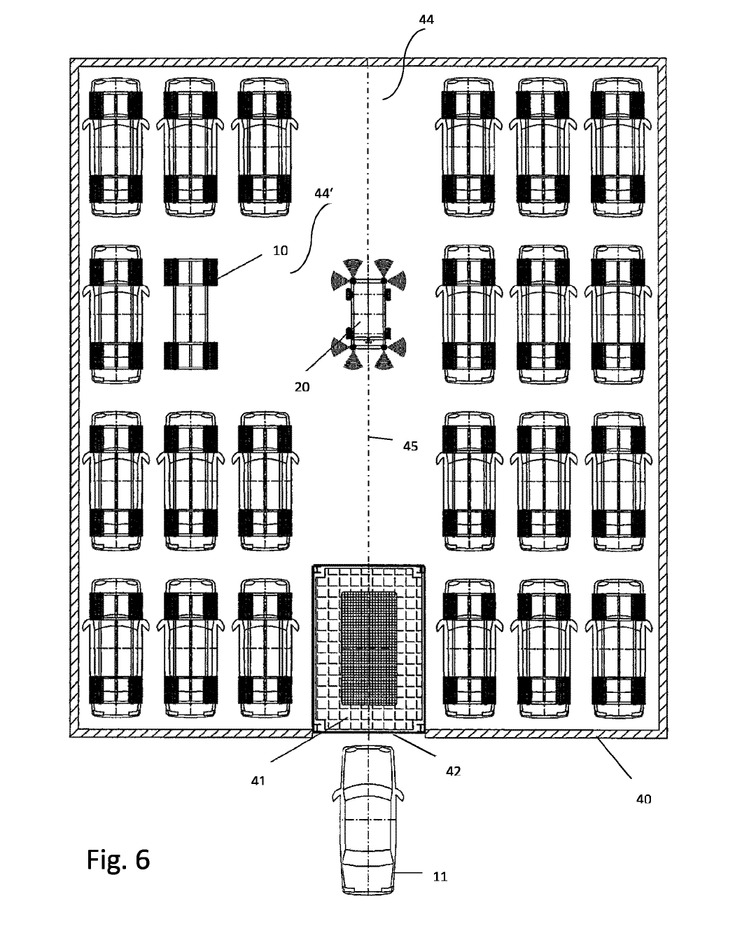

The operation of a respective parking system in a parking garage 30 is shown in FIG. 5 as an example. The parking garage 30 comprises a closed transfer station 31, into which a vehicle 11 can drive through a gate 32, which can be locked, to an empty pallet 10 placed there. The floor of the transfer station 11 is elevated by its supports in reference to the level of the parking garage 30 by the height of the pallet 10 and shows the level of the external road. It comprises recesses, into which the pallet and particularly its support sheets 14 can be inserted such that the vehicle 11 can drive horizontally onto the pallet 10.

Once the vehicle 11 has driven onto the pallet 10 and is securely parked there the maneuvering vehicle 20 drives under the pallet 10 and the pallet is lifted by the lifting plungers 21 of the maneuvering vehicle 20 to such an extent that the pallet can be driven out of the recesses in the floor of the transfer station 31. The maneuvering vehicle 20 then drives with the accepted pallet 10 and the vehicle 11 parked thereon in the y-direction to the position of an empty parking space 34 and then in the x-direction into a gap between already parked vehicles to the parking space 34. Here, the pallet 10 is parked. The maneuvering vehicle 20 can then drive to another empty pallet 10, parked on respective parking spaces, accept them and bring them to the transfer station 31 such that another vehicle 11 can be parked. If no other tasks are at hand, the maneuvering vehicle 20 can drive to a standby position (not shown) where a charging station is installed to be connected for charging the battery.

If a vehicle is to be retrieved, the maneuvering vehicle 20 moves to the respective parking space, drives under the pallet, on which the respective vehicle is parked, and raises it. Then it drives with the raised pallet in the x-direction to the moving alley and then in the y-direction to the transfer station 31. Perhaps, at first an empty pallet 10 located in the transfer station 31 must be removed and returned to an empty parking space. When the respective vehicle has been moved into the transfer station 31 the exit gate 33 is opened and the operator can receive his/her vehicle and drive off.

A second exemplary embodiment for a parking system according to the invention is shown in FIG. 6. In the parking garage 40 shown there, vehicles 11 parked on pallets 10 are stored, starting at a moving alley along the central line 45 in storage alleys for three vehicles each, which are parked laterally side-by-side. As discernible from the drawing, respectively only the first vehicle of a storage alley, seen from the moving alley, is directly accessible. If a vehicle stored further back in the storage alley is to be retrieved, here pallets with other vehicles located in front thereof can be relocated such that the vehicle located further back is accessible.

For the relocating process it is particularly advantageous that the pallets 10 are embodied such that the maneuvering vehicle 20 can pass under a stored pallet, namely both in the lateral as well as the longitudinal direction. This way any relocation can occur like a shift puzzle, with for example the empty space 44 at the end of the moving alley being used as an additional maneuvering area for the temporary relocation of pallets. This way the parking space available can be used in a particularly effective fashion. In order to increase access times and perhaps also accelerate potentially required relocations it is additionally advantageous to simultaneously operate with two or more maneuvering vehicles 20.

If a vehicle 11 wants to drive into the parking garage 40 as shown in the exemplary embodiment the maneuvering vehicle 20 must first pick up the single empty pallet 10 shown in FIG. 6 from its parking space and place it in the transfer station 41. Subsequently the access gate 42 of the parking garage 40 opens and the vehicle 11 can drive via a ramp (not shown) onto the empty pallet 10. The maneuvering vehicle 20 will then raise the pallet with the vehicle 11 and return it to its original parking space. The parking space 44 located in front of it remains clear in this case and is available as a movement area for a potential relocation.

In the exemplary embodiments shown respectively only one parking level was discussed. Of course, the parking garages 30, 40 shown may also be embodied with several levels and be equipped with an elevator system, preferably a hydraulic lift platform. The elevator system can for example be installed at the transfer station 31 and/or 41. If the elevator system is provided with a closed elevator cabin here simultaneously a transfer station is provided, closed at all sides, so that a user, upon drop-off and/or pick-up of his/her vehicle, is not required to access the parking level itself.

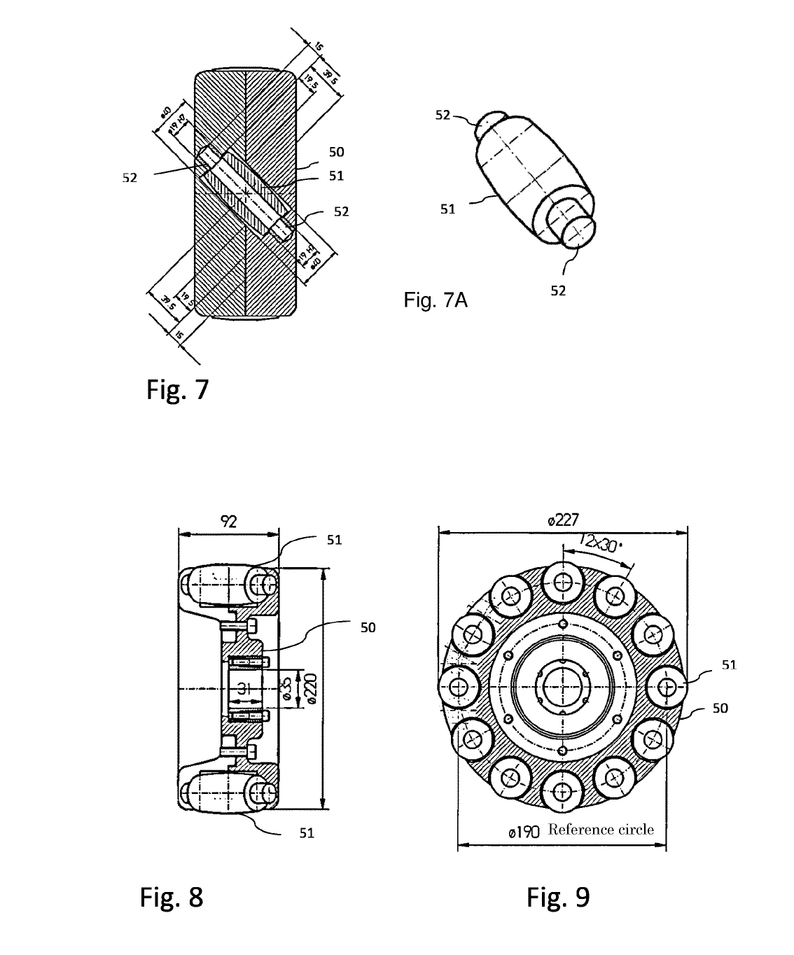

In the following, the principle of the omnidirectional drive, which is used for the maneuvering vehicle, is explained in greater detail based on FIGS. 7, 8, and 9. The core of the omnidirectional drive is a special wheel construction, which is also called omnidirectional wheel, by which the maneuvering vehicle can drive in any arbitrary direction at all times. Here, on the tread of a main wheel additional auxiliary wheels are provided, preferably cylindrical ones, with their axes of rotation being at an angle in reference to the axis of rotation of the main wheel. The precise geometry and arrangement of the wheels and their controls determine the driving behavior of the maneuvering vehicle. The individual wheels of the maneuvering vehicle are driven separately and independent from each other by electric motors and this way allow omnidirectional driving maneuvers without requiring any mechanical steering. A particular form of an omnidirectional wheel is the so-called Mecanum-wheel which is used in the exemplary embodiment of the invention shown here.

In a Mecanum-wheel several cylindrical rolls are arranged, supported rotationally on the tread of the wheel, and arranged at an angle of preferably 45° degrees in reference to the axis of the wheel. These rolls generate the contact to the ground. These rolls have no direct drive and can rotate freely about their inclined bearing axis. Each of the four Mechanum-wheels is here driven by a drive motor with variable directions of rotation and variable speeds. FIG. 7 shows schematically a top view of the tread of a Mecanum-wheel 50. From the cylindrical rolls 51 distributed along the tread of the Mecanum-wheel 50 here only the front-most one is shown in a cross-section as an example. The two ends of the roll 51 taper towards the bearing pin 52, which are supported in a freely rotational fashion via respective bearings at the tread of the wheel. An enlarged illustration of such a roll 51 is shown in FIG. 7A in an isometric view.

FIG. 8 shows a longitudinal cross-section through the Mecanum-wheel 50 and FIG. 9 shows a cross-section perpendicular to the axis of the wheel. Overall, twelve rolls 51 are distributed along the tread, with the rolls each generating the only contact of the Mecanum-wheel to the ground.

The four Mecanum-wheels of the maneuvering vehicle 20 are arranged such that the axes of the inclined rolls point in a stellar fashion to the center of the vehicle. By a suitable selection of speed and direction of rotation of each wheel here force vectors develop in reference to the ground, which form by the mobile rolls in two directions, which however in total with the force vectors of the other wheels, add to an overall direction of motion or an overall torque for the vehicle. Depending on the direction of the forces partially the rolls on the ground are set in motion or by the wheel on which they are located without the rolls here rotating, the latter for example when driving straight ahead. By the opposite direction of rotation of the wheels of the front and rear axles here the maneuvering vehicle driven in this fashion can drive laterally without moving in a longitudinal direction forward or backward or performing any rotation.

As an alternative to omnidirectional wheels, within the present invention also so-called drive-spin modules can be used, mentioned above, for the omnidirectional drive, thus integrated assemblies in which respectively a classical drive wheel is provided, which additionally can be rotated about its vertical axis and aligned.

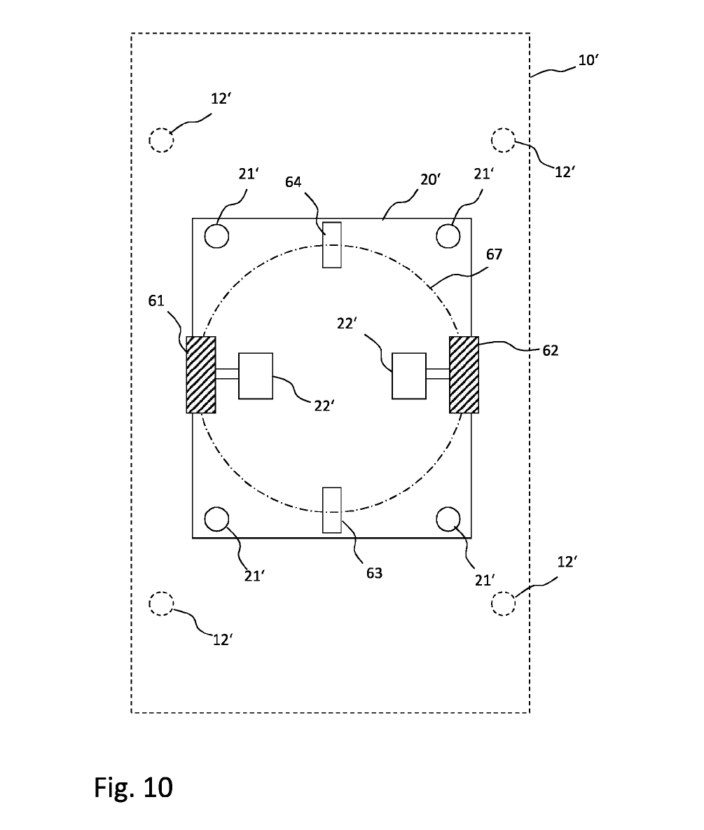

Finally, FIG. 10 shows another exemplary embodiment in which a maneuvering vehicle 20′ is equipped with a differential drive. The maneuvering vehicle 20′ comprises two driven wheels 61, 62, arranged approximately in the center with regards to the longitudinal sides, as well as two support wheels 63, 64, arranged approximately in the center with regards to the lateral sides, which support wheels being embodied in a freely rotational fashion about their vertical axes. The wheels 61, 62 are each separately connected to a corresponding drive 22′. The drives 22′ can be operated independent from each other both in the forward as well as the backward direction. If the two wheels 61, 62 are driven in opposite directions and with the same speed, the maneuvering vehicle spins on the spot about a virtual turning circle 67, indicated by dot-dash lines. The steering rolls 63, 64 follow each motion by rotating about their respective vertical axes and stabilize the maneuvering vehicle against tipping.

The maneuvering vehicle 20′ is equipped with four lifting plungers 21′, by which it can lift a pallet 10′ once it has driven under it. A pallet 10′ with its supports 12′ is here indicated only in dot-dash lines.

Although the differential drive 22′ allows spinning on the spot, however it enables no lateral motion like an omnidirectional drive. The maneuvering vehicle 20′ is therefore controlled such that for a lateral motion of a pallet 10′ accepted, here the pallet 10′ is initially lowered to the ground, the maneuvering vehicle 20′ then performs a rotation on the spot by 90°, and subsequently raises the pallet 10′ again. Now the maneuvering vehicle 20′ moves the pallet 10′ in the lateral direction. If the pallet 10′, after the lateral motion, shall continue moving in the longitudinal direction, the pallet 10′ is once more placed down, another rotation is performed by the maneuvering vehicle 20′ about 90°, and the pallet is then picked up again.

Here it is advantageous to provide receptacles at the pallet for a lifting plunger 21′ such that the pallet 10′ can be accepted only in fixed defined alignments of the maneuvering vehicle 20′. For this purpose the maneuvering vehicle 20′ is here equipped with sensors, which detect prior to the lifting process if the orientation of the maneuvering vehicle 20′ with regards to the seats at the pallet are consistent and the lifting plungers securely engage the receptacles and thus ensure that the pallet can only be accepted in the predefined orientation and/or position.

1. An automated parking system for vehicles, comprising a transfer station (31, 41) at which a vehicle (11) to be parked is dropped off onto one of a plurality of pallets (10, 10′) and a mechanical device (20, 20′) that accepts the pallet (10, 10′) and moves the pallet to a parking space (34) within a parking garage (30),
the plurality of pallets (10, 10′) are stored on parking spaces of the parking system, elevated in reference to a floor level, and
at least one robot-controlled, low-floor maneuvering vehicle (20, 20′) for transporting the pallets (10, 10′) that is drivable under the pallets, with the at least one robot-controlled, low-floor maneuvering vehicle (20, 20′) comprising an omnidirectional or differential drive (22, 61, 62) and being equipped with a lifting device (21, 21′) in order to lift one of the plurality of pallets (10, 10′) driven under, and the at least one robot-controlled, low-floor maneuvering vehicle (20, 20′) is equipped with distance sensors (24) for determining a position of the maneuvering vehicle (20, 20′) by measuring a distance from exterior walls of the parking garage (30).

2. The automated parking system according to claim 1, wherein the maneuvering vehicle (20) comprises as the omnidirectional drive individually controlled wheel drives with omnidirectional wheels (22).

3. The automated parking system according to claim 2, wherein the omnidirectional wheels (22) are embodied as Mecanum-wheels (50).

4. The automated parking system according to claim 1, further comprising a multi-story warehouse (30, 40) with an elevator system, which comprises a lifting platform or elevator cabin that at least one of the maneuvering vehicles (20) drives onto.

5. The automated parking system according to claim 4, further comprising an elevator shaft with an appropriately positioned lifting platform of elevator cabin of the elevator system serves as the transfer station for dropping off and picking up a vehicle (11) to be parked.

6. The automated parking system according to claim 1, further comprising a ramp at the transfer station (31, 41) which is embodied such that a vehicle (11) to be parked drives onto one of the pallets (10) provided at the transfer station (31, 41).

7. The automated parking system according to claim 1, wherein the maneuvering vehicle (20) is battery-operated and a charging station is provided, to which the maneuvering vehicle (20) is coupled in a standby mode.

8. The automated parking system according to claim 1, the maneuvering vehicle (20) is operated via high-performance capacitors and at least one inductive or tactile charging station is provided, which is embodied to charge the high-performance capacitors when the maneuvering vehicle (20) drives over the inductive or tactile charging station.

9. The automated parking system according to claim 1, wherein the maneuvering vehicle (20) comprises two distance sensors (24) each detecting at least one of a longitudinal or lateral direction.

10. The automated parking system according to claim 1, wherein two or more of the maneuvering vehicles (20) are provided, which perform at least one of simultaneous or alternating transportation of the pallets (10) between the transfer station (31, 41) and the various parking spaces (34).

11. The automated parking system according to claim 1, further comprising a central control that communicates via wireless data transmission with the at least one maneuvering vehicle (20) and is embodied to allocate parking spaces (34) to vehicles (11) to be parked and to determine a respective parking space of a vehicle (11) to be retrieved, on which the pallet (10) with said vehicle is stored.

12. The automated parking system according to claim 11, wherein the pallets (10) are stored behind one another in alleys and the central control unit is embodied to relocate one of the pallets (10) in order to generate access to the pallets (10) stored further back in one of the alleys.

13. The automated parking system according to claim 1, wherein using the maneuvering vehicle (20), one of the pallets (10) with a vehicle (11) to be returned from a respective parking space back to the transfer station (31, 41) is rotated by 180° in reference to a direction of entry.

14. The automated parking system according to claim 1, wherein the maneuvering vehicle (20) and the pallets (10) are embodied such that the maneuvering vehicle (10) passes under the pallets (10).

15. The automated parking system according to claim 1, wherein the maneuvering vehicle (20′) comprises a differential drive with two driven wheels (61, 62) arranged along a lateral axis, which are driven via corresponding drives (22′) separately and independent from each other, as well as at least one support wheel (63, 64) freely rotational about a vertical axis thereof.

16. The automated parking system according to claim 15, wherein the maneuvering vehicle (20′) is configured for lateral relocation of one of the pallets (10′) accepted in a longitudinal direction, by placing down the pallet (10′), performing underneath the pallet (10′) a rotation on the spot by 90°, and lifting the pallet (10′) again in the new orientation.

17. A low-floor, robot-controlled maneuvering vehicle (20, 20′) for a parking system according to claim 1, wherein the low-floor, robot-controlled maneuvering vehicle is embodied to drive under the pallets (10) supported at a distance from the floor level, and comprises an omnidirectional or differential drive (22; 22′) and a lifting device (21, 21′) for lifting one of the pallets (10, 10′) driven under.

18. A method for storing vehicles (11) in an automated parking system, comprising placing a vehicle (11) to be parked at a transfer station (31, 41) on a pallet (11), and accepting the pallet (11) by a mechanical device (20, 20′) and moved moving the pallet to a parking space (34), wherein
a plurality of the pallets (10, 10′) are supported on parking spaces of the parking system at such a distance from a floor level that a low-floor maneuvering vehicle (20, 20′) drives under at least one of the pallets, and
at least one robot-controlled low-floor maneuvering vehicle (20, 20′) is provided, and for transporting one of the pallets (10) from the transfer station (31, 41) to the parking space (34) or back the method further comprising driving the maneuvering vehicle under the pallet via an omnidirectional or differential drive (22, 22′) and lifting the pallet using a lifting device (21, 21′), with the maneuvering vehicle (20, 20′) being equipped with distance sensors (24) for determining a location of the maneuvering vehicle (20, 20′) by measuring a distance from exterior walls of the parking garage (30).
